(19) United States
(12) Patent Application Publication
(10) Pub. No.: US 2026/0118645 A1
(43) Pub. Date: Apr. 30, 2026

(54) CAMERA MODULE

(71) Applicant: SAMSUNG ELECTRO-MECHANICS CO., LTD., Suwon-si (KR)

(72) Inventors: Jaeki EOM, Suwon-si (KR); Hae-Seung HYUN, Suwon-si (KR)

(73) Assignee: SAMSUNG ELECTRO-MECHANICS CO., LTD., Suwon-si (KR)

(21) Appl. No.: 19/072,407

(22) Filed: Mar. 6, 2025

(30) Foreign Application Priority Data
Oct. 30, 2024 (KR) 10-2024-0150369

(51) Int. Cl. G02B 13/00

(52) U.S. Cl. CPC G02B 13/0065

(57) ABSTRACT

A camera module including a first lens module having at least one lens, a second lens module having at least one lens and disposed spaced apart from the first lens module, a folded module that changes the path of at least one of a first incident light incident in a first direction from the first lens module and a second incident light incident in the first direction from the second lens module, and an image sensor that converts at least one of the first incident light and the second incident light, the path of which is changed by the folded module, into an electrical signal, wherein the folded module includes a first prism disposed under the first lens module, and a second prism disposed under the second lens module and having a refractive index different from that of the first prism.

### CROSS-REFERENCE TO RELATED APPLICATIONS

This application claims the benefit under 35 USC 119 (a) of Korean Patent Application No. 10-2024-0150369 filed on Oct. 30, 2024, in the Korean Intellectual Property Office, the entire disclosure of which is incorporated herein by reference for all purposes.

### BACKGROUND

### 1. Field

The present disclosure relates to a camera module.

### 2. Description of the Background

With the significant development of information, communication and semiconductor technologies, the supply and use of portable terminals have rapidly increased. Cameras are currently used in portable electronic devices such as smartphones, tablet PCs, and laptop computers.

Smartphone cameras have front cameras and rear cameras, and various types of cameras are used for the rear cameras, such as wide-angle cameras, ultra-wide-angle cameras, high-magnification telephoto cameras, and low-magnification telephoto cameras.

As the number of cameras used in smartphones increases, the overall camera mounting area is increasing, and in particular, telephoto cameras occupy a large portion of the overall camera area due to their structural characteristics. In addition, the recent trend of high-performance cameras has led to the adoption of high-pixel image sensors, which has increased the area occupied by an image sensor. For this reason, there may be a problem of insufficient mounting space for other components such as batteries.

Therefore, miniaturization technology capable of reducing the overall camera area while maintaining the existing functions of the camera may be desired.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a camera module includes a first lens module including at least one lens, a second lens module including at least one lens and disposed spaced apart from the first lens module, a folded module that changes the path of at least one of a first incident light incident in a first direction from the first lens module and a second incident light incident in the first direction from the second lens module, and an image sensor that converts at least one of the first incident light and the second incident light, the path of which is changed by the folded module, into an electrical signal, wherein the folded module includes a first prism disposed under the first lens module, and a second prism disposed under the second lens module and having a refractive index different from that of the first prism.

The image sensor may be disposed laterally close to the second prism, and a light receiving surface may be disposed perpendicular to the direction of light incident from the folded module.

The first prism may reflect the first incident light in a second direction, and the second prism may transmit the first incident light reflected in the second direction and reflect the second incident light in the second direction.

The first prism may have a lower refractive index than the second prism.

The first prism and the second prism may be bonded with an optical adhesive.

The optical adhesive may have a refractive index that is the same as or lower than that of the first prism.

The camera module may further include a third lens module disposed between the second prism and the image sensor, and have an optical axis perpendicular to the first lens module and the second lens module.

The image sensor may be disposed below the second lens module with the folded module interposed therebetween, and the light receiving surface of the image sensor may be disposed perpendicular to the direction of light incident from the folded module.

The first prism may reflect the first incident light in the second direction and transmit the second incident light, and the second prism may reflect the first incident light reflected in the second direction in the first direction and transmit the second incident light.

The first prism may have a higher refractive index than the second prism.

The first prism and the second prism may be bonded with an optical adhesive, and the optical adhesive may have a refractive index that is the same as or lower than that of the second prism.

The first prism may include a metal coating layer on a reflective surface on which the first incident light is reflected.

The first lens module may have a higher magnification than the second lens module.

In another general aspect, a camera module includes a first lens module including at least one lens, a second lens module including at least one lens and disposed spaced apart from the first lens module, a folded module that changes the path of at least one of a first incident light incident in a first direction from the first lens module and a second incident light incident in the first direction from the second lens module, and an image sensor that converts at least one of the first incident light and the second incident light, the path of which is changed by the folded module into an electrical signal, wherein the folded module includes a first prism disposed under the first lens module, and a second prism disposed under the second lens module and spaced apart from the first prism, and wherein the second prism includes an upper prism and a lower prism combined and having different refractive indices from each other.

The image sensor may be disposed laterally close to the second prism, the first prism may reflect the first incident light in a second direction, and the second prism may transmit the first incident light reflected in the second direction and reflect the second incident light in the second direction.

The upper prism may have a higher refractive index than the lower prism.

The image sensor may be disposed under the second lens module with the folded module interposed therebetween, the first prism may reflect the first incident light in the second direction, and the second prism may reflect the first incident light reflected in the second direction in the first direction and transmit the second incident light.

The upper prism may have a lower refractive index than that of the lower prism.

The camera module may further include a third lens module between the first prism and the second prism.

The camera module may further include a third lens module between the second prism and the image sensor.

Other features and aspects will be apparent from the following detailed description, the drawings, and the claims.

### BRIEF DESCRIPTION OF THE DRAWINGS

FIG. 1 is a perspective view illustrating the exterior of a camera module according to an embodiment.

FIG. 2 is an exploded perspective view illustrating the camera module shown in FIG. 1.

FIG. 3 is a perspective view of a portion of the camera module shown in FIG. 1.

FIG. 4 is a front view of FIG. 3.

FIG. 5 is a cross-sectional view of a portion of the camera module shown in FIG. 1.

FIG. 6 is a schematic illustration of a light path of the camera module shown in FIG. 1.

FIG. 7 is an exploded perspective view of a camera module according to another embodiment.

FIG. 8 is a schematic illustration of a light path of the camera module shown in FIG. 7.

FIG. 9 is a schematic illustration of a camera module according to another embodiment.

FIG. 10 is a schematic illustration of a camera module according to another embodiment.

FIG. 11 is a schematic illustration of a camera module according to another embodiment.

FIG. 12 is a schematic illustration of a camera module according to another embodiment.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

In addition, the phrase “on a plane” means a view from a position above the object (e.g., from the top), and the phrase “in a cross-section” means a view of a cross-section of the object which is vertically cut from the side.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Throughout the specification, the term “connected” does not mean only that two or more constituent components are directly connected, but may also mean that two or more constituent components are indirectly connected through another constituent component, that two or more components are electrically connected as well as physically connected, or that two or more constituent components are referred to by different names but are united by location or function.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

One aspect of the embodiments described herein may provide a camera module capable of focusing light incident from different types of lens modules onto a single image sensor.

Hereinafter, the optical axis may be set as the central axis of the lens perpendicular to the lens surface, and the optical axis direction (Y-axis direction) means the direction parallel to the central axis. In the drawings, the optical axis is set as the Y-axis, and the X-axis and Z-axis are set in the direction perpendicular to the optical axis. In this case, the X-axis and the Z-axis are perpendicular to each other, and the x-z plane formed by the X-axis and the Z-axis becomes a plane perpendicular to the optical axis.

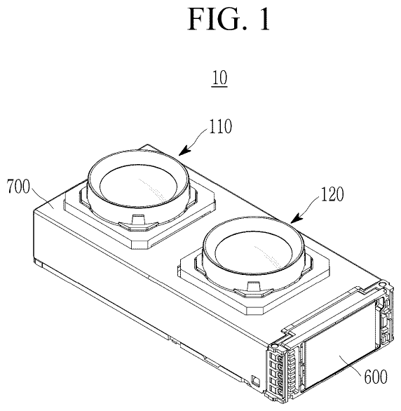

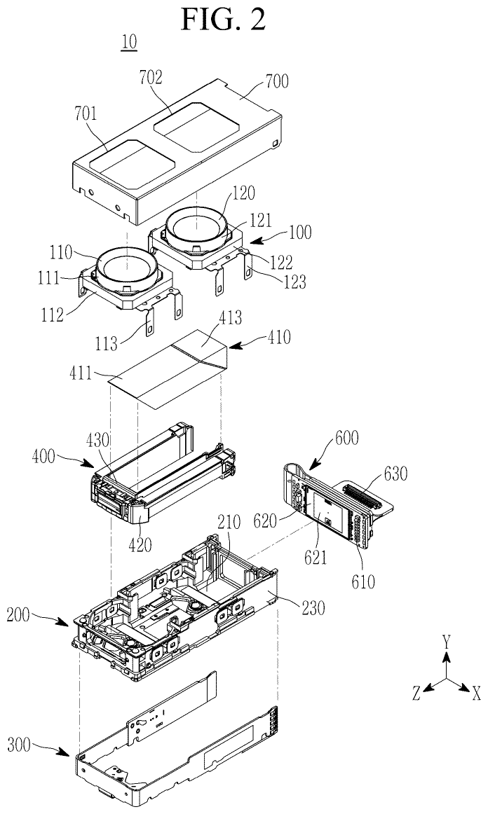

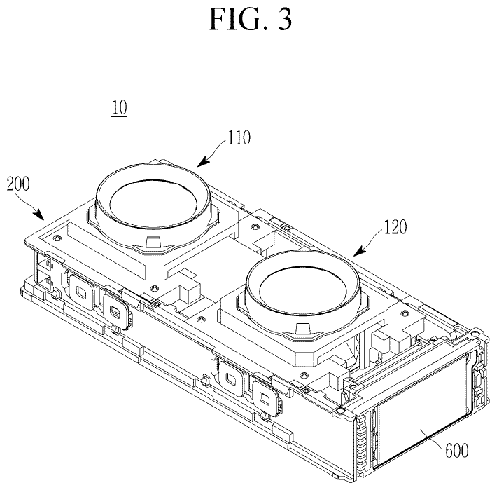

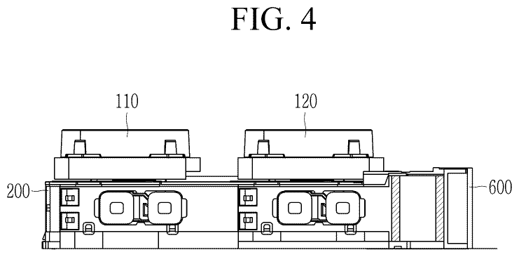

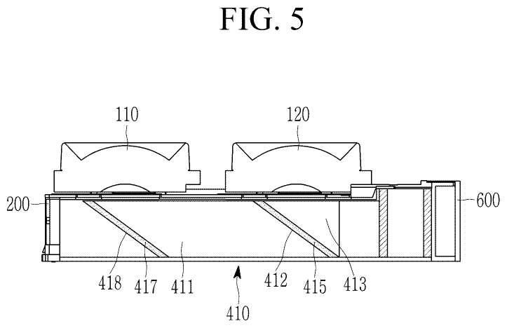

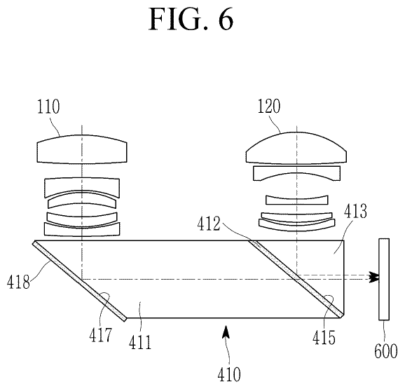

FIG. 1 is a perspective view illustrating the exterior of a camera module according to an embodiment, FIG. 2 is an exploded perspective view illustrating the camera module shown in FIG. 1, FIG. 3 is a perspective view of a portion of the camera module shown in FIG. 1, FIG. 4 is a front view of FIG. 3, FIG. 5 is a cross-sectional view of a portion of the camera module shown in FIG. 1, and FIG. 6 is a schematic illustration of a light path of the camera module shown in FIG. 1.

Referring to FIGS. 1 to 5, a camera module 10 according to the present embodiment includes a lens module 100, a housing 200, and a circuit board 300 that surrounds the housing 200 from the outside. A folded module 400 may be accommodated in the internal space of the housing 200.

The camera module 10 may include a cover 700 that partially surrounds the housing 200. The cover 700 may prevent components accommodated inside the housing 200 from being separated from the housing 200. For example, the housing 200 may have a box shape with an upper part open. That is, the housing 200 may have a bottom portion 210 and a side portion 230 having a quadrangular shape on a plane. The cover 700 may have a box shape with an open bottom so that the upper part of the housing 200 may be closed. The folded module 400 may be disposed in a space surrounded by the housing 200 and the cover 700.

The cover 700 may include a material capable of shielding electromagnetic waves. The cover 700 may block or minimize electromagnetic waves generated inside the camera module 10 from escaping outside the camera module 10 and electromagnetic waves outside the camera module 10 from entering inside the camera module 10. For example, the cover 700 may be a shield can.

The cover 700 may have openings 701 and 702. A portion of the lens module 100 may protrude to the outside through the openings 701 and 702 formed on the cover 700. External light may enter through the openings 701 and 702 of the cover. A lens accommodated in the lens module 100 may be disposed in the direction in which light travels.

The lens module 100 includes a first lens module 110 and a second lens module 120, and may be partially covered by the cover 700. The first lens module 110 and the second lens module 120 have optical axes that are parallel to each other and may be disposed spaced apart in a direction perpendicular to the optical axis. The first lens module 110 may partially protrude to the outside through the first opening 701 of the cover 700, and the second lens module 120 may partially protrude to the outside through the second opening 702 of the cover 700.

The first lens module 110 may include a first lens barrel 111 and a first lens holder 112. The first lens barrel 111 accommodates at least one lens. The first lens barrel 111 may have a cylindrical shape with an internal space formed therein. The internal space may accommodate a plurality of lenses. The plurality of lenses may be arranged in a first direction (Y-axis direction). Individual lenses included in the plurality of lenses may have unique optical characteristics. For example, individual lenses included in the plurality of lenses may have different refractive indices. The first lens barrel 111 may at least partially protrude to the outside through the first opening 701 of the cover 700.

The first lens holder 112 may accommodate the first lens barrel 111. The first lens holder 112 may include a first facing area 113 that at least partially contacts the side portion 230 of the housing 200. The first facing area 113 may be accommodated at least partially in the interior space of the housing 200. The first lens holder 112 may be at least partially covered by the cover 700.

The first lens module 110 may cover a portion of the folded module 400. The first lens module 110 may be coupled with the housing 200 by contacting the outer side of the side portion 230 of the housing 200.

A first incident light incident in the first direction (Y-axis direction) from the outside of the first lens module 110 may pass through the first lens module 110 and move to the folded module 400.

The second lens module 120 may include a second lens barrel 121 and a second lens holder 122. The second lens module 120 is disposed spaced apart from the first lens module 110 in a direction perpendicular to the optical axis, and may have a different magnification from the first lens module 110. For example, the first lens module 110 may have a higher magnification than the second lens module 120, and the first lens module 110 may be a high-magnification telephoto lens and the second lens module 120 may be a low-magnification telephoto lens. The present disclosure is not limited thereto, and various modifications are possible, such as the first lens module 110 being a telephoto lens and the second lens module 120 being a wide-angle lens.

The second lens module 120 may have a plurality of lenses accommodated in the second lens barrel 121 arranged in the first direction (Y-axis direction) so as to have an optical axis parallel to the optical axis of the first lens module 110. At least a portion of the second lens barrel 121 may protrude to the outside through the second opening 702 of the cover 700.

The second lens holder 122 may accommodate the first lens barrel 111. The second lens holder 122 may include a second facing area 123 that at least partially contacts the side portion 230 of the housing 200. The second facing area 123 may be accommodated at least partially in the interior space of the housing 200. The second lens holder 122 may be at least partially covered by the cover 700.

The second lens module 120 may partially cover the folded module 400. The second lens module 120 may be coupled with the housing 200 by contacting the outer side of the side portion 230 of the housing 200.

A second incident light incident in the first direction (Y-axis direction) from the outside of the second lens module 120 may pass through the second lens module 120 and move to the folded module 400.

The first lens module 110 and the second lens module 120 may include at least a portion of an AF driver. For example, the first lens module 110 and the second lens module 120 may each include an AF magnet. The first lens module 110 and the second lens module 120 may move along the optical axis by electromagnetic interaction between the AF magnet and an AF coil mounted on the circuit board 300.

The first lens module 110 and the second lens module 120 may include a shutter (not shown) that blocks light from entering respective upper parts thereof. When light incident on either of the first lens module 110 and the second lens module 120 is desired to be received, a shutter may be used to selectively block light incident on the other.

The folded module 400 may change the light path by refracting at least one of the first incident light incident in the first direction (Y-axis direction) from the first lens module 110 and the second incident light incident in the first direction from the second lens module 120. The light whose path has been changed by the folded module 400 reaches an image sensor module 600. The folded module 400 may include a refractive member 410 that changes the light path.

The refractive member 410 may include a first prism 411 disposed under the first lens module 110 and a second prism 413 disposed under the second lens module 120. The first prism 411 may extend to the bottom of the second lens module 120, and the first prism 411 and the second prism 413 may be bonded with an optical adhesive 415.

The first prism 411 may reflect the first incident light incident in the first direction (Y-axis direction) from the first lens module 110 to a second direction (Z-axis direction), and the second prism 413 may transmit the first incident light reflected in the second direction and reflect the second incident light incident in the first direction from the second lens module 120 to the second direction.

The first prism 411 and the second prism 413 may be formed of a material that reflects or refracts light, and may have different refractive indices. For example, the first prism 411 may have a lower refractive index than the second prism 413.

An optical adhesive 412 may have a predetermined refractive index, and may have a refractive index that is the same as the first prism 411 or lower than the first prism 411 and the second prism 413. The present disclosure is not limited thereto, and the first prism 411 and the second prism 413 may be disposed spaced apart from each other without being bonded, or may be disposed in contact with each other.

The first prism 411 may have a polyhedron shape with an inclined reflective surface 417 that reflects the first incident light incident from the first lens module 110, and may be, for example, a parallelogram whose y-z plane has a diagonal line extending from under the first lens module 110 to under the second lens module 120. A metal coating layer 418 may be formed on the reflective surface 417 so that all of the first incident light incident from the first lens module 110 is reflected in the second direction and directed toward the second prism 413.

The second prism 413 may have a polyhedron shape with an inclined reflective surface 415 that reflects the second incident light incident in the first direction from the second lens module 120. The second prism 413 may have a higher refractive index than the first prism 411 so that the first incident light reflected in the second direction from the reflective surface 417 of the first prism 411 is transmitted therethrough.

The folded module 400 includes a carrier 420 and a rotation holder 430 accommodated in the carrier 420. The refractive member 410 may be coupled to the rotation holder 430. For example, the carrier 420 may be supported by a ball group (not shown) disposed between the bottom portion 210 of the housing 200 and the carrier 420, and may rotate around on a first axis parallel to the first direction (Y-axis direction). Additionally, the rotation holder 430 may be supported by a second ball group (not shown) disposed between the carrier 420 and the rotation holder 430, and may rotate around a second axis parallel to a third direction (X-axis direction). As the carrier 420 or the rotation holder 430 rotates, the refractive member 410 accommodated in the rotation holder 430 may also rotate.

The folded module 400 may include at least a portion of an optical image stabilization (OIS) driver. For example, the folded module 400 may include an OIS magnet. The folded module 400 may rotate around an axis perpendicular to the optical axis by electromagnetic interaction between the OIS magnet and an OIS coil mounted on the circuit board 300.

The image sensor module 600 includes a sensor substrate 610 and an image sensor 620 disposed on the sensor substrate 610. The image sensor 620 is a device that receives at least one of the first incident light and the second incident light incident from the folded module 400 and converts it into an electrical signal, and may be either a charge coupled device (CCD) or a complementary metal oxide semiconductor (CMOS), but is not limited thereto.

The image sensor 620 has a light receiving surface 621 that receives at least one of the first incident light and the second incident light. The image sensor 620 may be disposed laterally close (adjacent) to the second prism 413 so that the light receiving surface 621 of the light is perpendicular to the direction of the light whose path has been changed by the folded module 400. That is, the image sensor 620 is disposed so that the light receiving surface 621 faces the side surface of the second prism 413, so that the light receiving surface 621 is perpendicular to the direction of light reflected in the second direction (Z-axis direction) through the folded module 400. An image may be formed on the light receiving surface 621 by light reaching the image sensor 620. The image sensor 620 may generate an electrical signal for an image formed on the light receiving surface 621. The electrical signal may be transmitted to an external circuit through a connector 630.

The housing 200 may accommodate the folded module 400 and may have an opening that exposes the OIS coil to the inside of the housing 200 toward the OIS magnet. Additionally, the housing 200 may have an opening that exposes the AF coil to the inside of the housing 200 toward the AF magnet.

The circuit board 300 may be disposed to surround the housing 200 from the outside. In other words, the circuit board 300 may surround at least a portion of the side portion 230 of the housing 200. For example, the circuit board 300 may have a shape that is bent twice. The housing 200 may have a box shape with an upper part open having the bottom portion 210 and four side portions 230, and in this case, the circuit board 300 that is bent twice may be disposed to surround three of the four side portions 230 of the housing 200. The circuit board 300 may include a flexible printed circuit board (FPCB) or a rigid flexible printed circuit board (RFPCB).

At least a portion of the OIS driver and at least a portion of the AF driver may be disposed on the circuit board 300. For example, the OIS coil and the AF coil may be disposed on the circuit board 300. That is, the OIS coil and the AF coil may be disposed in the housing 200 via the circuit board 300.

The camera module 10 may provide an optical image stabilization (OIS) function. If the camera shakes unintentionally due to hand tremors or other causes when shooting, the OIS function may compensate for this. For example, the camera module 10 may provide the OIS function by driving the folded module 400 by the OIS driver.

The OIS driver may include the OIS magnet and the OIS coil. For example, the OIS magnet may be disposed in the folded module 400, and the OIS coil may be disposed on the circuit board 300. The OIS magnet and the OIS coil may be disposed to face each other, and when power is supplied to the OIS coil through the circuit board 300, the folded module 400 may rotate around the first axis parallel to the first direction (Y-axis direction) due to electromagnetic interaction between the OIS coil and the OIS magnet. The OIS magnet and the OIS coil may be disposed as a set to correspond to each lens module. The present disclosure is not limited thereto, and the OIS driver including the OIS magnet and the OIS coil may be disposed in a lens holder.

The camera module 10 may provide an auto focus (AF) function. The AF function may automatically focus on the subject. For example, the camera module 10 may provide the AF function by driving the first lens module 110 and the second lens module 120 by an auto focus (AF) driver.

The AF driver may include the AF magnet and the AF coil, the AF magnet may be disposed in the lens module 100, and the AF coil may be disposed on the circuit board 300.

The AF magnet and the AF coil may be disposed to face each other, and when power is supplied to the AF coil through the circuit board 300, the lens module 100 may move in the optical axis direction (Y-axis direction) by electromagnetic interaction between the AF coil and the AF magnet. The AF magnet and the AF coil may be disposed as a set in each lens module.

Referring to the light path of the camera module according to the present embodiment with reference to FIG. 6, the first incident light that is incident in the first direction on the first lens module 110 is reflected in the second direction toward the second prism 413 from the reflective surface 417 of the first prism 411, and the first incident light reflected in the second direction and incident on the second prism 413 is transmitted through the second prism 413 and incident on the image sensor module 600. In this case, the second prism 413 may have a higher refractive index than the first prism 411, and therefore, the first incident light incident on the second prism 413 may be transmitted through the second prism 413. For example, the first prism 411 may have a refractive index of 1.487, and the second prism 413 may have a refractive index of 2.0. The first prism 411 and the second prism 413 may be bonded with the optical adhesive 412, and the refractive index of the optical adhesive 412 may be the same as or lower than that of the first prism 411—for example, 1.375.

The second incident light incident in the first direction on the second lens module 120 may be totally reflected in the second direction on the reflective surface 415 of the second prism 413 and then incident onto the image sensor module 600. In this case, the refractive index of the second prism 413 may be higher than the refractive index of the first prism 411 so that the second incident light is totally reflected on the reflective surface 415 of the second prism 413. In order to selectively admit the first incident light incident on the first lens module 110 and the second incident light incident on the second lens module 120, the first lens module 110 and the second lens module 120 may each include a shutter (not shown) on the upper part. That is, the shutter may be used to control the incidence of the first incident light or the second incident light.

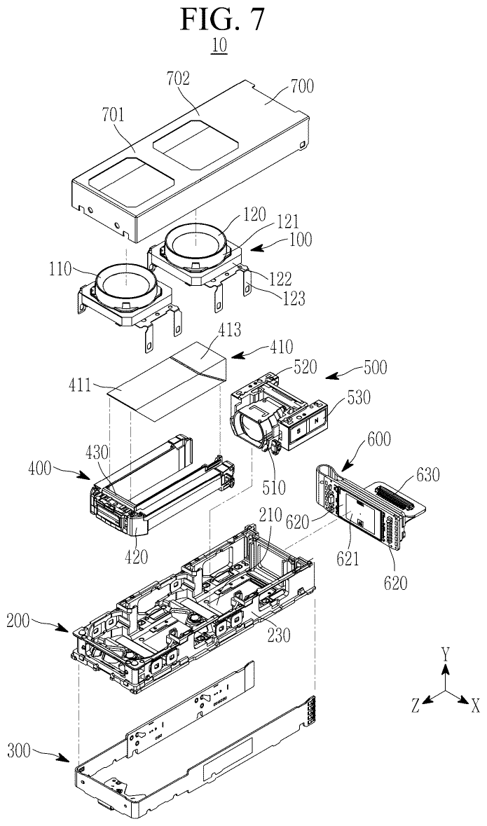

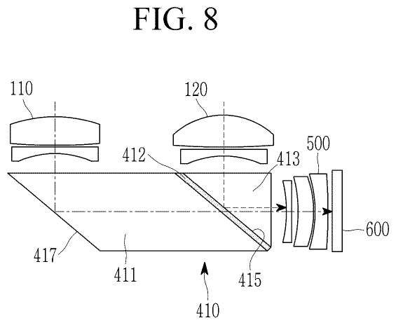

Hereinafter, a camera module according to another embodiment will be described with reference to FIGS. 7 and 8. FIG. 7 is an exploded perspective view of a camera module according to another embodiment, and FIG. 8 is a schematic illustration of a light path of the camera module shown in FIG. 7.

The camera modules illustrated in FIGS. 7 and 8 have substantially the same configuration as the embodiments described with reference to FIGS. 1 to 5. Below, different configurations are described, and the same drawing symbols are used for the same configurations, and configurations not described separately may be configured in the same manner as the embodiments illustrated in FIGS. 1 to 5.

Referring to FIG. 7, the camera module according to the present embodiment includes a third lens module 500 between the folded module 400 and the image sensor module 600. Specifically, the third lens module 500 may be disposed between the second prism 413 and the image sensor 620, and may include a third lens barrel 510 and a third lens holder 520. The third lens barrel 510 may accommodate a plurality of lenses in the internal space thereof. The plurality of lenses may be arranged in the second optical axis direction (Z-axis direction). That is, the third lens module 500 may have an optical axis perpendicular to the first lens module 110 and the second lens module 120.

The third lens holder 520 may accommodate the third lens barrel 510. The third lens holder 520 is supported by a ball group (not shown) located between the bottom portion 210 of the housing 200 and the third lens holder 520 and may move in the second optical axis direction. As the third lens holder 520 moves in the second optical axis direction, the third lens barrel 510 accommodated in the third lens holder 520 may also move in the second optical axis direction. The distance between the lenses and the image sensor may change depending on the movement of the third lens barrel 510. That is, the third lens barrel 510 may move in the second optical axis direction, and accordingly, the camera module 10 may provide the AF function.

The third lens module 500 may include at least a portion of the AF driver. For example, the third lens module 500 may include an AF magnet 530. The third lens module 500 may move in the second optical axis by electromagnetic interaction between the AF magnet 530 and the AF coil mounted on the circuit board 300.

The first and second incident lights, whose paths are changed by the folded module 400, pass through the third lens module 500 and then reach the image sensor module 600.

According to the present embodiment, since the first lens module 110 and the second lens module 120 use the third lens module 500 in common, the number of lenses used in the first lens module 110 and the second lens module 120 may be reduced. For example, if the first lens module 110 and the second lens module 120 are telephoto lenses with different magnifications, the first lens module 110 and the second lens module 120 may each include one group of lenses, and the third lens module 500 may include two groups of lenses. This enables the height of the camera module to be reduced, thereby facilitating a thinner camera module.

Referring to the light path of the camera module according to the present embodiment with reference to FIG. 8, the first incident light that is incident in the first direction on the first lens module 110 is reflected in the second direction toward the second prism 413 from the reflective surface 417 of the first prism 411, and the first incident light reflected in the second direction and incident on the second prism 413 is transmitted through the second prism 413 and incident on the third lens module 500. The first incident light incident on the third lens module 500 is refracted by the third lens module 500 and then incident on the image sensor module 600. In this case, the second prism 413 may have a higher refractive index than the first prism 411, and therefore, the first incident light reflected in the second direction and incident on the second prism 413 may be transmitted through the second prism 413. The first prism 411 and the second prism 413 may be bonded with the optical adhesive 412, and the refractive index of the optical adhesive 412 may be the same as or lower than that of the first prism 411.

The second incident light incident in the first direction to the second lens module 120 is totally reflected in the second direction by the reflective surface 415 of the second prism 413 and is incident on the third lens module 500, and the second incident light incident on the third lens module 500 may be refracted by the third lens module 500 and incident on the image sensor module 600. In this case, the refractive index of the second prism 413 may be higher than the refractive index of the first prism 411 so that the second incident light is totally reflected on the reflective surface 415 of the second prism 413. In order to selectively admit the first incident light incident on the first lens module 110 and the second incident light incident on the second lens module 120, the first lens module 110 and the second lens module 120 may each include a shutter (not shown) on the upper part.

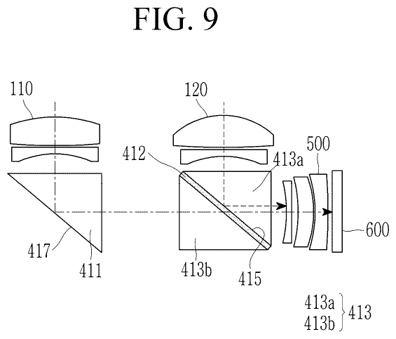

Hereinafter, camera modules according to various embodiments will be described with reference to FIGS. 9 to 12. FIGS. 9 to 12 are schematic illustrations of a camera module according to other embodiments.

The camera modules illustrated in FIGS. 9 to 12 have substantially the same configuration as the embodiments described with reference to FIGS. 1 to 5. Below, different configurations are described, and the same drawing symbols are used for the same configurations, and configurations not described separately may be configured in the same manner as the embodiments illustrated in FIGS. 1 to 5.

Referring to FIG. 9, the camera module according to the present embodiment includes the refractive member 410 including the first prism 411 and the second prism 413, and the third lens module 500 between the second prism 413 and the image sensor module 600.

The first prism 411 is disposed below the first lens module 110, and the second prism 413 is disposed below the second lens module 120. The first prism 411 may be spaced apart from the second prism 413 in a direction perpendicular to the optical axis direction (Y-axis direction). The second prism 413 may be a combination of an upper prism 413a and a lower prism 413b having different refractive indices. The upper prism 413a and the lower prism 413b may be bonded using the optical adhesive 412.

The third lens module 500 includes at least a portion of the AF driver so that the third lens module 500 may move in the second optical axis direction (Z-axis direction), and thus the camera module 10 may provide the AF function. The third lens module 500 may have an optical axis perpendicular to the first lens module 110 and the second lens module 120. Since the first lens module 110 and the second lens module 120 use the third lens module 500 in common, the number of lenses used in the first lens module 110 and the second lens module 120 may be reduced, thereby facilitating the thinner camera module.

Referring to the light path of the camera module according to the present embodiment with reference to FIG. 9, the first incident light that is incident in the first direction on the first lens module 110 is reflected in the second direction toward the lower prism 413b from the reflective surface 417 of the first prism 411, the first incident light reflected in the second direction is transmitted through the lower prism 413b and the upper prism 413a and is then incident on the third lens module 500, and the first incident light incident on the third lens module 500 is refracted by the third lens module 500 and is then incident on the image sensor module 600. In this case, the upper prism 413a may have a higher refractive index than the lower prism 413b, and therefore, the first incident light incident from the lower prism 413b to the upper prism 413a may be transmitted through the upper prism 413a. For example, the lower prism 413b may have a refractive index of 1.487, and the upper prism 413a may have a refractive index of 2.0. The upper prism 413a and the lower prism 413b may be bonded with the optical adhesive 412, and the refractive index of the optical adhesive 412 may be the same as or lower than that of the lower prism 413b.

The second incident light incident in the first direction to the second lens module 120 is totally reflected in the second direction by the reflective surface 415 of the upper prism 413a and is incident on the third lens module 500, and the second incident light incident on the third lens module 500 may be refracted by the third lens module 500 and incident on the image sensor module 600. In this case, the refractive index of the upper prism 413a may be higher than the refractive index of the lower prism 413b so that the second incident light is totally reflected on the reflective surface 415 of the upper prism 413a. In order to selectively admit the first incident light incident on the first lens module 110 and the second incident light incident on the second lens module 120, the first lens module 110 and the second lens module 120 may each include a shutter (not shown) on the upper part.

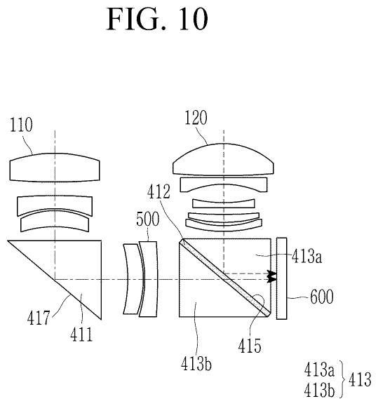

Referring to FIG. 10, the camera module according to the present embodiment includes the reflective member 410 including the first prism 411 and the second prism 413, and the third lens module 500 between the first prism 411 and the second prism 413.

The first prism 411 is disposed below the first lens module 110, and the second prism 413 is disposed below the second lens module 120. The first prism 411 may be spaced apart from the second prism 413 in a direction perpendicular to the optical axis direction (Y-axis direction). The second prism 413 may be a combination of an upper prism 413a and a lower prism 413b having different refractive indices. The upper prism 413a and the lower prism 413b may be bonded using the optical adhesive 412.

The third lens module 500 includes at least a portion of the AF driver so that the third lens module 500 may move in the optical axis direction (Z-axis direction), thereby providing the AF function to the first lens module 110. The third lens module 500 may have an optical axis perpendicular to the first lens module 110. Since the third lens module 500 is disposed on the path of light incident through the first lens module 110, the number of lenses used in the first lens module 110 may be reduced. For example, if the first lens module 110 is a high-magnification telephoto lens and the second lens module 120 is a low-magnification telephoto lens, some of the high-magnification telephoto lenses may be disposed in the first lens module 110 so that the first lens module 110 has the same height as the second lens module 120, and the remainder may be disposed in the third lens module 500. Therefore, the height of the first lens module 110 with high-magnification may be made the same as that of the second lens module 120, thereby reducing the overall height of the camera module.

Referring to the light path of the camera module according to the present embodiment with reference to FIG. 10, the first incident light that is incident in the first direction on the first lens module 110 is reflected in the second direction toward third lens module 500 from the reflective surface 417 of the first prism 411, and the first incident light incident on the third lens module 500 is refracted by the third lens module 500 and incident on the lower prism 413b. The first incident light is transmitted through the lower prism 413b and the upper prism 413a and then is incident on the image sensor module 600. In this case, the upper prism 413a may have a higher refractive index than the lower prism 413b, and therefore, the first incident light incident from the lower prism 413b to the upper prism 413a may be transmitted through the upper prism 413a. For example, the lower prism 413b may have a refractive index of 1.487, and the upper prism 413a may have a refractive index of 2.0. The upper prism 413a and the lower prism 413b may be bonded with the optical adhesive 412, and the refractive index of the optical adhesive 412 may be the same as or lower than that of the lower prism 413b.

The second incident light incident in the first direction to the second lens module 120 may be totally reflected in the second direction by the reflective surface 415 of the upper prism 413a and incident on the image sensor module 600. In this case, the refractive index of the upper prism 413a may be higher than the refractive index of the lower prism 413b so that the second incident light is totally reflected on the reflective surface 415 of the upper prism 413a. In order to selectively admit the first incident light incident on the first lens module 110 and the second incident light incident on the second lens module 120, the first lens module 110 and the second lens module 120 may each include a shutter (not shown) on the upper part.

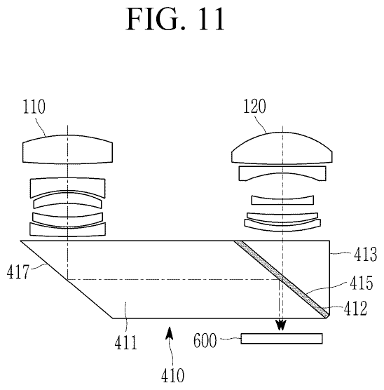

Referring to FIG. 11, the camera module according to the present embodiment may have the image sensor module 600 disposed under the refractive member 410. Specifically, the image sensor module 600 may be disposed below the second lens module 120 with the refractive member 410 therebetween, and may be disposed so that the light receiving surface is perpendicular to the direction of light incident from the folded module 400. That is, the light receiving surface of the image sensor module 600 may be disposed to face the lower surface of the refractive member 410.

The first lens module 110 and the second lens module 120 may be telephoto lenses having different magnifications, or the first lens module 110 may be a telephoto lens and the second lens module 120 may be a wide-angle lens.

The refractive member 410 includes the first prism 411 and the second prism 413, the first prism 411 is disposed below the first lens module 110, and the second prism 413 is disposed below the second lens module 120. The first prism 411 and the second prism 413 may have different refractive indices and may be bonded using the optical adhesive 412.

Referring to the light path of the camera module according to the present embodiment with reference to FIG. 11, the first incident light that is incident in the first direction on the first lens module 110 is reflected in the second direction from the reflective surface 417 of the first prism 411 toward the second prism 413, and the first incident light reflected in the second direction is reflected again in the first direction from the reflective surface 415 of the second prism 413 toward the image sensor module 600 and is incident on the image sensor module 600. In this case, the second prism 413 may have a lower refractive index than the first prism 411, and thus, the first incident light reflected in the second direction may be totally reflected in the first direction at the reflective surface 415 of the second prism 413 and may be incident on the image sensor module 600. For example, the first prism 411 may have a refractive index of 2.0, and the second prism 413 may have a refractive index of 1.478. The refractive index of the optical adhesive 412 may be the same as or lower than that of the second prism 413.

The second incident light incident in the first direction to the second lens module 120 may be transmitted through the second prism 413 and the first prism 411 and may be incident on the image sensor module 600. At this time, the refractive index of the second prism 413 may be lower than the refractive index of the first prism 411 so that the second incident light may be transmitted through the first prism 411. In order to selectively admit the first incident light incident on the first lens module 110 and the second incident light incident on the second lens module 120, the first lens module 110 and the second lens module 120 may each include a shutter (not shown) on the upper part.

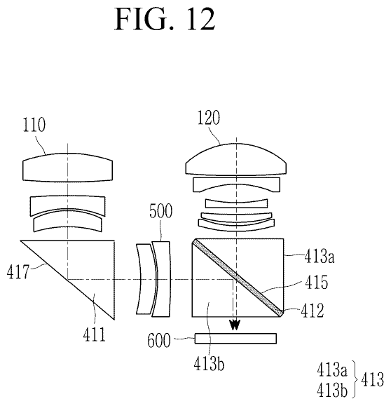

Referring to FIG. 12, the camera module according to the present embodiment includes the reflective member 410 including the first prism 411 and the second prism 413, the third lens module 500 between the first prism 411 and the second prism 413, and the image sensor module 600 may be disposed under the refractive member 410.

The first prism 411 is disposed below the first lens module 110, and the second prism 413 is disposed below the second lens module 120. The first prism 411 may be spaced apart from the second prism 413 in a direction perpendicular to the optical axis direction (Y-axis direction). The second prism 413 may be a combination of the upper prism 413a and the lower prism 413b having different refractive indices. The upper prism 413a and the lower prism 413b may be bonded using the optical adhesive 412.

The third lens module 500 includes at least a portion of the AF driver so that the third lens module 500 may move in the second optical axis direction (Z-axis direction), thereby providing the AF function to the first lens module 110. The third lens module 500 may have an optical axis perpendicular to the first lens module 110. Since the third lens module 500 is disposed on the path of light incident through the first lens module 110, the number of lenses used in the first lens module 110 may be reduced. For example, if the first lens module 110 is a high-magnification telephoto lens and the second lens module 120 is a low-magnification telephoto lens, a portion of the high-magnification telephoto lens may be disposed in the first lens module 110 so that the first lens module 110 has the same height as the second lens module 120, and the remainder may be disposed in the third lens module 500. Therefore, the height of the first lens module 110 with high magnification may be made the same as that of the second lens module 120, thereby reducing the overall height of the camera module. The present embodiment is not limited thereto, and various modifications are possible, such as the first lens module 110 being a telephoto lens and the second lens module 120 being a wide-angle lens.

Specifically, the image sensor module 600 may be disposed below the second lens module 120 with the refractive member 410, particularly with the second prism 413 therebetween, and may be disposed so that the light receiving surface is perpendicular to the direction of light incident from the folded module 400. That is, the image sensor module 600 may be disposed so that the light receiving surface faces the lower surface of the second prism 413.

Referring to the light path of the camera module according to the present embodiment with reference to FIG. 12, the first incident light that is incident in the first direction on the first lens module 110 is reflected in the second direction toward the third lens module 500 from the reflective surface 417 of the first prism 411, and the first incident light that is reflected in the second direction and is incident on the third lens module 500 is refracted by the third lens module 500 and is incident on the lower prism 413b. The first incident light is reflected in the first direction again from the reflective surface of the lower prism 413b toward the image sensor module 600 and is incident on the image sensor module 600. In this case, the refractive index of the lower prism 413b may be higher than the refractive index of the upper prism 413a so that the first incident light is totally reflected on the reflective surface of the lower prism 413b and is incident on the image sensor module 600.

The second incident light incident in the first direction to the second lens module 120 may be transmitted through the upper prism 413a and the lower prism 413b and be incident on the image sensor module 600. In this case, the refractive index of the upper prism 413a may be lower than that of the lower prism 413b so that the second incident light may be transmitted through the upper prism 413a and the lower prism 413b and then is incident on the image sensor module 600. The refractive index of the optical adhesive 412 may be same as or lower than that of the upper prism 413a.

In order to selectively admit the first incident light incident on the first lens module 110 and the second incident light incident on the second lens module 120, the first lens module 110 and the second lens module 120 may each include a shutter (not shown) on the upper part.

According to one or more of the embodiments described herein, it may be possible to reduce the overall mounting area of the camera module.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A camera module, comprising:
a first lens module comprising at least one lens;
a second lens module comprising at least one lens and disposed spaced apart from the first lens module;
a folded module that changes the path of at least one of a first incident light incident in a first direction from the first lens module and a second incident light incident in the first direction from the second lens module; and
an image sensor that converts at least one of the first incident light and the second incident light, the path of which is changed by the folded module, into an electrical signal,
wherein the folded module comprises a first prism disposed under the first lens module, and a second prism disposed under the second lens module and having a refractive index different from that of the first prism.

2. The camera module of claim 1, wherein
the image sensor is disposed laterally close to the second prism, and a light receiving surface is disposed perpendicular to the direction of light incident from the folded module.

3. The camera module of claim 2, wherein
the first prism reflects the first incident light in a second direction,
and the second prism transmits the first incident light reflected in the second direction and reflects the second incident light in the second direction.

4. The camera module of claim 2, wherein
the first prism has a lower refractive index than that of the second prism.

5. The camera module of claim 1, wherein
the first prism and the second prism are bonded with an optical adhesive.

6. The camera module of claim 5, wherein
the optical adhesive has a refractive index that is the same as or lower than that of the first prism.

7. The camera module of claim 1, further comprising
a third lens module disposed between the second prism and the image sensor and having an optical axis perpendicular to the first lens module and the second lens module.

8. The camera module of claim 1, wherein
the image sensor is disposed under the second lens module with the folded module interposed therebetween, and the light receiving surface of the image sensor is disposed perpendicular to the direction of light incident from the folded module.

9. The camera module of claim 8, wherein
the first prism reflects the first incident light in the second direction and transmits the second incident light,
and the second prism reflects the first incident light reflected in the second direction in the first direction and transmits the second incident light.

10. The camera module of claim 8, wherein
the first prism has a higher refractive index than that of the second prism.

11. The camera module of claim 8, wherein
the first prism and the second prism are bonded with an optical adhesive, and the optical adhesive has a refractive index that is the same as or lower than that of the second prism.

12. The camera module of claim 1, wherein
the first prism includes a metal coating layer on a reflective surface on which the first incident light is reflected.

13. The camera module of claim 1, wherein
the first lens module has a higher magnification than the second lens module.

14. A camera module, comprising:
a first lens module comprising at least one lens;
a second lens module comprising at least one lens and disposed spaced apart from the first lens module;
a folded module that changes the path of at least one of a first incident light incident in a first direction from the first lens module and a second incident light incident in the first direction from the second lens module; and
an image sensor that converts at least one of the first incident light and the second incident light, the path of which is changed by the folded module, into an electrical signal,
wherein the folded module comprises a first prism disposed under the first lens module, and a second prism disposed under the second lens module and spaced apart from the first prism, and
wherein the second prism comprises an upper prism and a lower prism combined and having different refractive indices from each other.

15. The camera module of claim 14, wherein
the image sensor is disposed laterally close to the second prism,
the first prism reflects the first incident light in a second direction,
and the second prism transmits the first incident light reflected in the second direction and reflects the second incident light in the second direction.

16. The camera module of claim 15, wherein
the upper prism has a higher refractive index than the lower prism.

17. The camera module of claim 15, further comprising
a third lens module between the first prism and the second prism.

18. The camera module of claim 15, further comprising
a third lens module between the second prism and the image sensor.

19. The camera module of claim 14, wherein
the image sensor is disposed under the second lens module with the folded module interposed therebetween,
the first prism reflects the first incident light in the second direction,
and the second prism reflects the first incident light reflected in the second direction in the first direction and transmits the second incident light.

20. The camera module of claim 19, wherein
the upper prism has a lower refractive index than that of the lower prism.

21. The camera module of claim 19, further comprising
a third lens module between the first prism and the second prism.
